(19) United States
(12) Patent Application Publication
(10) Pub. No.: US 2009/0268641 A1
(43) Pub. Date: Oct. 29, 2009

(54) Method for Switching a Mobile Station between Groups in Wimax Networks

(76) Inventors: Raymond Yim, Cambridge, MA (US); Andreas F. Molisch, Arlington, MA (US); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/108,863

(22) Filed: Apr. 24, 2008

(51) Int. Cl. H04B 7/00

(52) U.S. Cl. 370/277

(57) ABSTRACT

A method switches a mobile station (MS) from a current group to a new group in a Worldwide Interoperability for Microwave Access (WiMAX) including a base station (BS). The BS operates in full duplex mode and the MS operates in half-duplex mode, such that the WiMAX network operates in semi-duplex mode. The MS receives from the BS, while the MS is in the current group, a group switching request in a downlink (DL) sub-frame. The MS also receives structural information regarding frames of the new group. The MS switches from the current group to the new group after receiving the structural information.

### FIELD OF THE INVENTION

This invention relates generally to wireless communication networks, and more particularly to FDD group-switching in Worldwide Interoperability for Microwave Access networks.

### BACKGROUND OF THE INVENTION

Draft 4 of the IEEE 802.16 Rev 2 standard specifies a Frequency Division Duplexing (FDD) frame structure and a FDD signaling mode for Worldwide Interoperability for Microwave Access (WiMAX) networks. In the FDD mode, the transmitter and receiver can operate in two different frequency bands. This enables a base station (BS) to concurrently communicate with different mobile stations (MSs) in an uplink (UL) and a downlink (DL).

Typically, the BS operates in full-duplex mode. The MS can operate in half-duplex or full-duplex mode. To operate in full-duplex, the MS need to be able to transmit and receive at the same time. This increase cost and complexity.

The WiMAX network partitions the MSs into two FDD groups, e.g. group 1 and group 2. Within each orthogonal division multiple access (OFDMA) frame, MS1 in group 1 participates first in the DL1 transmission and then in the UL1 transmissions, while the MS2 in group 2 participates first in the UL2 and then in the DL2 transmissions in a frame 101. UL1 and UL2 transmissions use the same frequency band, while DL1 and DL2 transmissions use the same frequency band that is different from UL transmissions.

Network parameters are defined to enable the MSs to acquire the time intervals for their respective UL and DL transmissions. The durations, in units of OFDMA symbols, of the UL and DL sub-frames are specified in the MAP regions of the FDD groups.

The BS indicates structure of the frames for both groups. The structure includes a size of DL1 of the current (n^{th}) frame using the “No. of OFDMA symbols” field in DL-MAP1. The same field in the DL-MAP2 indicates A size of DL2 of the next frame. For the UL, the BS indicates, in the “No. OFDMA symbols” in UL-MAP1 and UL-MAP2, A size of UL1 of the next frame and A size of UL2 of the next-next (n+2) frame respectively.

For reasons such as load balancing, the standard enables the BS to request a MS in a specific FDD group to switch to another group.

The following describes the conventional operation for switching the MS from group 1 to 2, and vice versa, respectively. Specifically, after the MS receives a group switch request in frame n, the MS switches to the new group and decode the downlink sub-frame in frame n+H-FDD_Group_Switch_Delay+m, where m denotes the current group number, and H-FDD_Group_Switch_Delay is either specified in the UL Channel Descriptor (UCD), or it defaults to H-ARQ ACK Delay. Furthermore, the BS can request the MS to explicitly acknowledge (ACK) a group switch instruction, in which case the BS assigns a one-time Channel Quality Information Channel (CQICH) for the acknowledgement. In response to receiving the ACK the BS switches immediately.

The mechanisms for frame structure signaling and group switching potentially lead to a problem that is difficult to handle as shown in FIGS. 2-3. FIG. 2 shows successive frames 101-105, uplink (UL) 111 and downlink (DL) 112 transmissions for each frame of group 1. Figure shows the same for group 2.

Specifically, MS1 receives the request 121 to switch groups in the DL1 of frame n. If the BS request a switching acknowledgement (ACK) 122 and H-FDD_Group_Switch_Delay is equal to H-ARQ ACK Delay as specified by the current standard, then the group switching ACK 122 is transmitted in the UL1 at frame n+1. In the same frame, the BS transmits in the structure for the DL2 and UL2 for subsequent frames n+2 and n+3, respectively. However, if the MS cannot transmit and receive at the same time, it cannot decode 202 this sub-frame (X) 201, and after the switch 110 structure of the frames for the new group, i.e., the size of the DL2/UL2 sub-frame, is unknown 250 to the MS.

The similar problem occurs when a MS switches from group 2 to 1 as shown in FIG. 3. A possible solution requires the MS to have the capability to concurrently transmit/receive in the two frequency bands and operate in Full-duplex. This increases the cost of receivers.

Therefore, there is a need to enable group switching without having the MS to transmit and receive concurrently. Up to now the standard committees including representatives from many communication companies have been unable to solve this problem because a solution is not obvious.

### SUMMARY OF THE INVENTION

The embodiments of the invention define group switching protocols that solve the above problem when mobile stations (MSs) switch groups in a Worldwide Interoperability for Microwave Access (WiMAX) network. The idea is to define the timing of a group switching protocol in such a way that the MS only needs to transmit or receive at a given time. That is operations in the network are semi-duplex where the BS operates in full-duplex and the MS operates in half-duplex.

The embodiments of the invention also define several example implementations that achieve the goal of semi-duplex operation in group switching protocols. One embodiment uses advance signaling of frame structures, i.e., sub-frame size and MAP information of the new FDD group, while the MS is still in the current group, and the second embodiment uses an additional frame for MAP scanning in the new group.

The embodiments of the invention provide group switching methods for WiMAX that eliminate the need to receive at one frequency band, while the MS is transmitting at another frequency band during an FDD group switching operation.

One method uses idle frames to facilitate FDD group switching, and enables the MS to obtain a new frame structure for the new group, i.e., UL/DL sub-frame sizes, and/or locations of its DL/UL data traffic during FDD group switching. The method specifies structural information for the new group while the MS is associated with the current group.

### BRIEF DESCRIPTION OF THE DRAWINGS

FIG. 1A is a schematic of a WiMAX network according to embodiments of the invention;

FIG. 1B is a block diagram of a FDD frame structure and frame size signaling mechanism according to embodiments of the invention;

FIG. 2 is a block diagram of prior art FDD group-switching signaling mechanism for switching an MS from Group 1 to Group 2;

FIG. 3 is a block diagram of prior art FDD group-switching signaling mechanism for switching an MS from Group 2 to Group 1;

FIG. 4 is a block diagram of example protocols for FDD group switching from Group 1 to Group 2 according to method 1 in embodiments of the invention;

FIG. 5 is a block diagram of example protocols for FDD group switching from Group 2 to Group 1 according to method 1 in embodiments of the invention;

FIGS. 6-7 are block diagrams of example protocols for FDD group switching from Group 1 to Group 2 according to method 2 in embodiments of the invention; and

FIG. 8 is a block diagram of an example protocol for FDD group switching from Group 2 to Group 1 according to method 2 in embodiments of the invention.

### DETAILED DESCRIPTION OF THE PREFERRED EMBODIMENTS

The embodiments of our invention provide a method for switching a mobile station (MS) between Frequency Division Duplexing (FDD) groups in a Worldwide Interoperability for Microwave Access (WiMAX) network. In the following, we describe two specific embodiments that achieve this goal. However, the fundamental principle is not limited to these example embodiments.

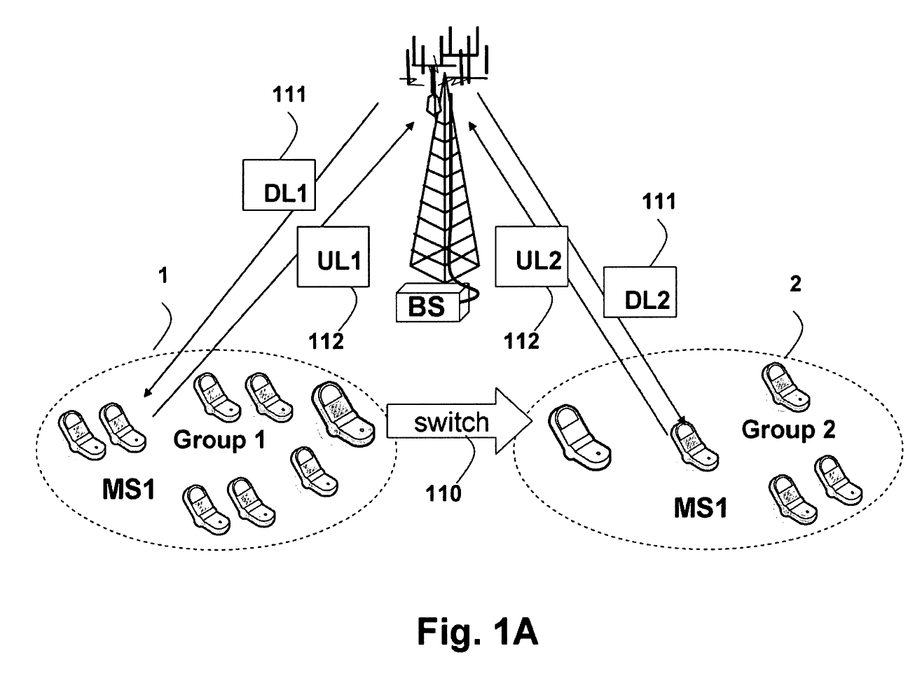

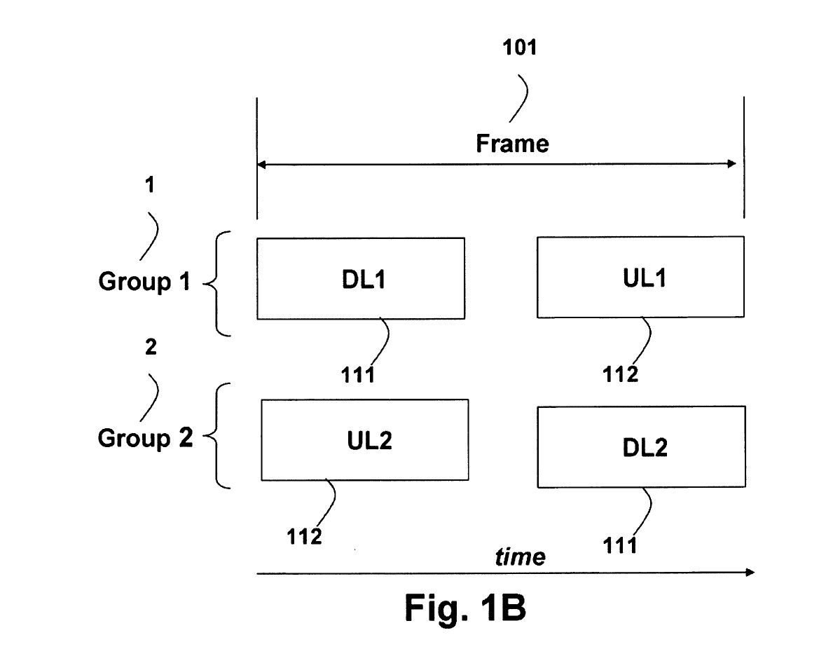

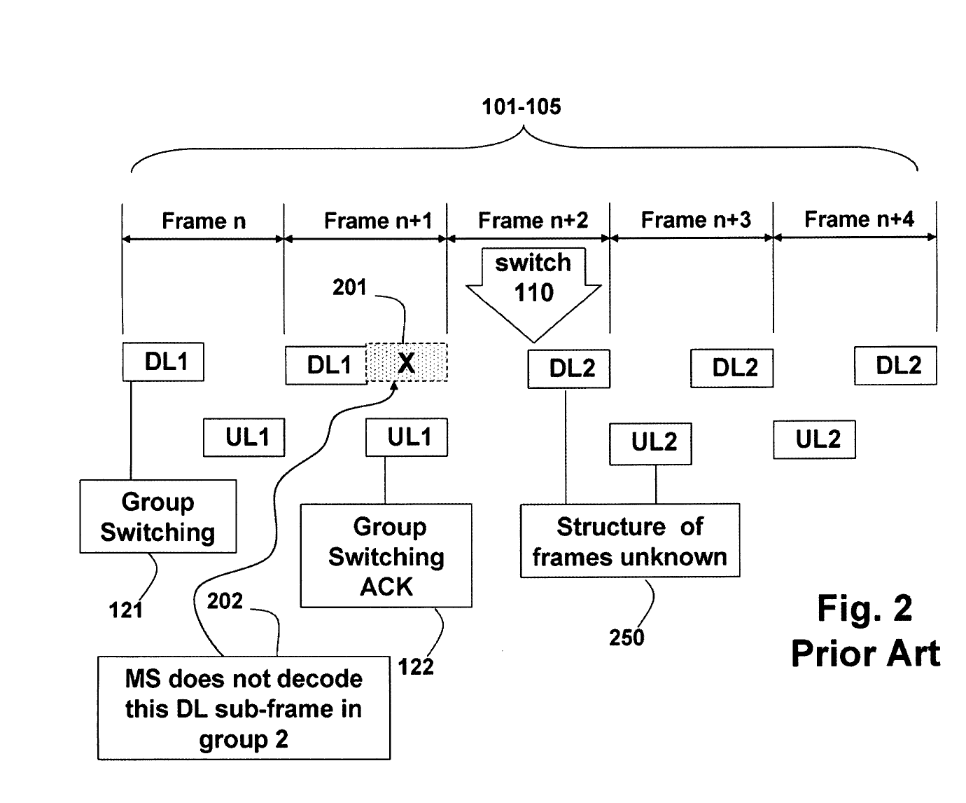

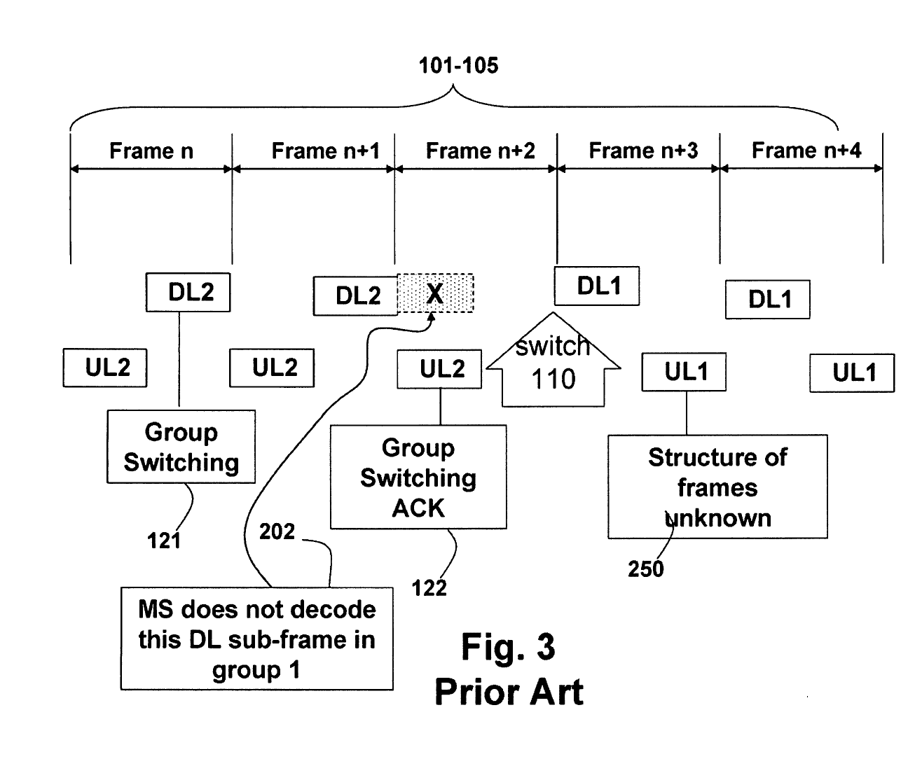

FIG. 1A shows a base station (BS) operating in full-duplex mode and mobile station operating in half-duplex mode. That is, the network is semi-duplex. The BS and MS alternate transmissions on a DL 111 and an UL 112. The MS is half-duplex and cannot transmit and receive at the same time.

As shown in FIGS. 1A-1B, the WiMAX network partitions the MSs into two FDD groups, e.g. group 1 and group 2. Within each OFDMA frame, MS1 in group 1 participates first in the DL1 transmission 111 and then in the UL1 transmissions, while the MS2 in group 2 participates first in the UL2 and then in the DL2 transmissions with a frame 101.

Method 1: Advanced Signaling of Subframe Size and MAP Information of the New FDD Group While the MS is Still in the Current Group

Before the MS transmits or receives data traffic in the new FDD group, structural information. The structural information can include the start of the DL MAP, the UL sub-frame size, the DL sub-frame size, the UL region for data, and the DL region for data.

This information can be transmitted by:

Adding information to the group switch request message;

Allowing the UL-MAP and DL-MAP message transmitted in a particular FDD group to contain information regarding a new UL/DL sub-frame size of another FDD group;

Using a MAP message to communicate any or all of the above information to the MS, while the MS is still in the current FDD group.

The groups switching can then be acknowledges by the MS, if so requested by the BS.

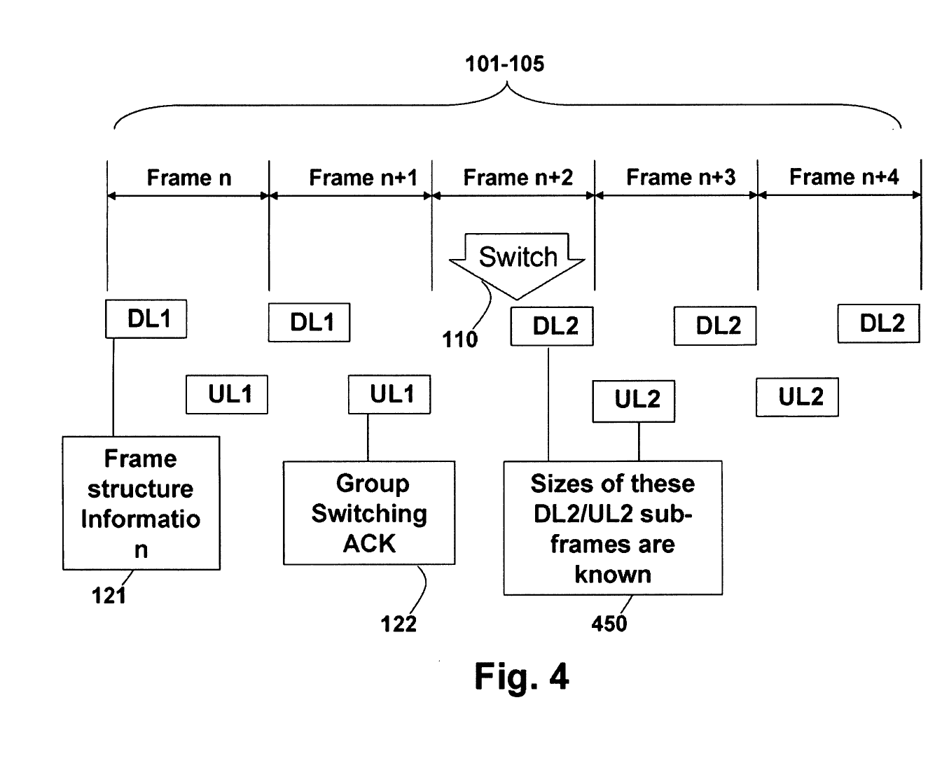

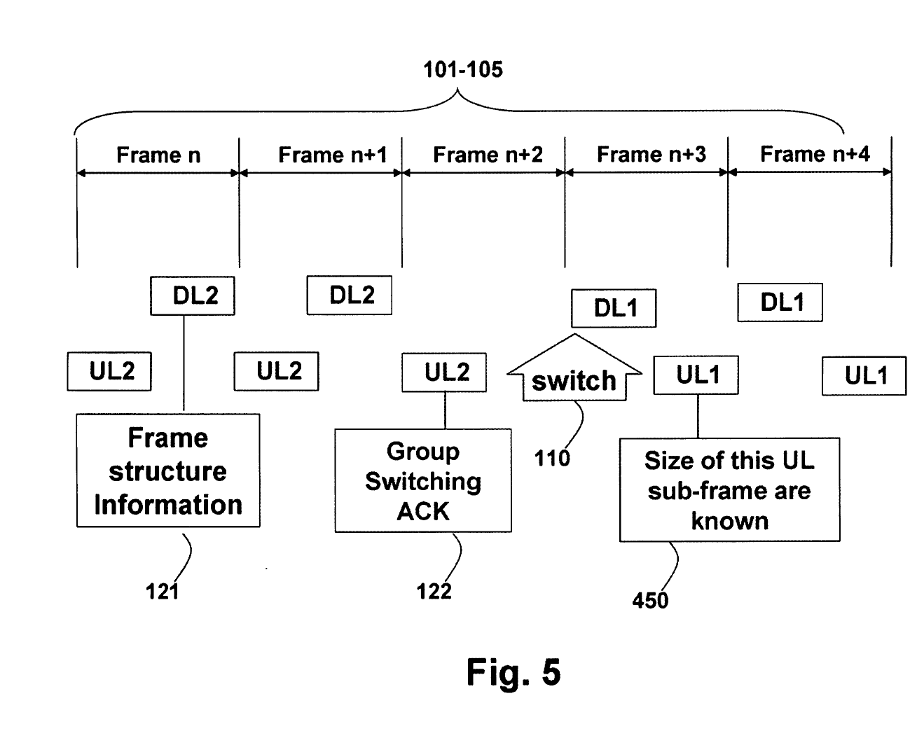

Some examples of our protocols are shown in FIGS. 4-5 for switching between groups. The MS in group 1 received the group switch request and frame structure information 121 in the DL1 of frame n. The switch request is acknowledged in the UL1 of the next frame n+1. The MS switches 110 from group 1 to group 2 in the next frame n+2. Now, the structure of the DL2 in this and subsequent frames is known 450. FIG. 5 shows the identical process for switching from group 2 to group 1, but for a delay because of the reverse order of the DL and UL sub-frames.

The information regarding the frame structure can be incorporated by modifying the HFDD_Group_Switch_IE defined in Table 361, Sec 8.4.5.3.28, of 802.16 Rev 2 of Draft 4 of the IEEE 802.16 Rev 2 standard. Changes in the Table are italicized, bolded and underlined.

TABLE 361

| Syntax | Size | Notes |
|---|---|---|
| HFDD_Group_Switch_IE( ) { | — | — |
| Extended DIUC | 4 | HFDD_Group_Switch_IE( ) = 0x0D |
| Length | 4 | |
| RCID_Type | 2 | 0b00: Normal CID |
| | | 0b01: RCID11 |
| | | 0b10: RCID7 |
| | | 0b11: RCID3 |
| While (data remains){ | | |
| RCID | variable | |
| Group Indicator | 1 | Indicates the group assignment of the MS |
| | | (see 8.4.4.1 for FDD frame structure and |
| | | group definition) |
| | | 0b0: Group #1 |
| | | 0b1: Group #2 |
| CQICH Allocation Included | 1 | 0b0: CQICH Allocation Not Included |
| | | 0b1: CQICH Allocation Included |
| if (CQICH Allocation Included==1) { | | |
| Allocation Index | 6 | Index to the channel in a frame the CQI code |
| | | should be transmitted by the SS |
| } | | |
| New DL structure Info Included | 1 | DownlinkStructural Information after the |
| | | MS enters the new group |
| if (New DL info included == 1) { | | |
| No. OFDMA Symbols | 8 | Downlink sub-frame size of the new group |
| } | | |
| New UL Info Included | 1 | UplinkStructure Information after the MS |
| | | enters the new group |
| if (New UL info imicluded == 1) } | | |
| No. OFdMA Symbols | 8 | Uplink sub-frame size of the new group |
| } | | |
| } | | |
| Padding | Variable | Padding to byte; shall be set to 0 |
| } | — | — |

An example for allowing a DL or UL MAP to communication information regarding the future location of DL/UL traffic in another FDD group adds an additional field to all relevant DL_MAP_IE and UL_MAP_IE.

| Syntax | Size | Notes |
|---|---|---|
| xxx_yy_MAP_IE( ) { | — | — |
| . . . | . . . | . . . |
| Group Indicator | 1 | Indicates the relevance of this MAP IE |
| | | 0b0: Group #1 |
| | | 0b1: Group #2 |
| . . . | . . . | . . . |
| } | | |

Method 2: Additional Frame for MAP Scanning in the New Group

Between the frame when the BS sends a group switch request 121 to the MS and the frame where the MS transmits or receives data traffic in the new FDD group, one or more idle frames 501 are transmitted by the BS where no data traffic is transmitted or received by the MS.

During the idle frame(s), the MS can perform any of the following:

MS determines a start position of the DL MAP in the new group;

MS determines the MAP information at a specific location in the DL sub-frame;

MS decodes DL MAP;

MS obtains UL sub-frame size of a frame in the MAP for the new group;

MS obtains DL sub-frame size of a frame in the MAP for the new group;

MS obtains UL region for its data at a future frame;

MS obtains DL region for its data at a future frame;

Because the difference between FDD_Group_Switch_Delay and H-ARQ ACK Delay, which determines the frame at which the MS sends the group switch acknowledge 122, is the number of idle frames 501, i.e.,

FDD_Group_Switch_Delay>H-ARQ ACK Delay.

Conventionally, the default value is

H-FDD Group Switching Delay=H-ARQ ACK Delay.

We change this to

H-FDD Group Switching Delay=H-ARQ ACK Delay+1.

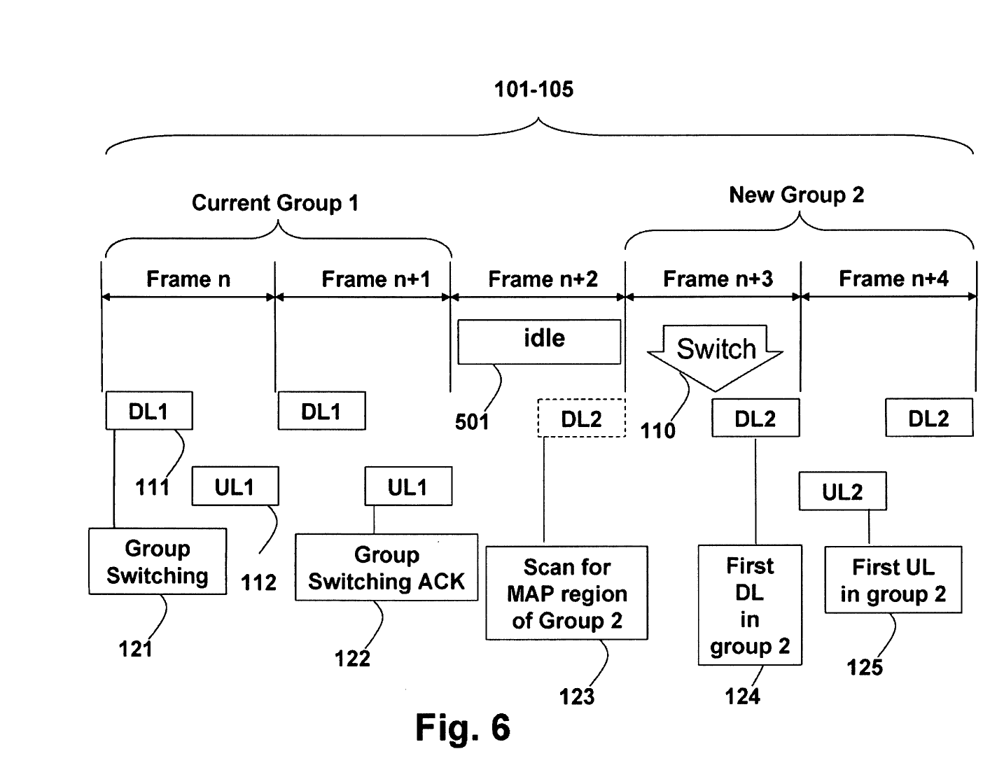

Some examples of our protocols are shown in FIGS. 6-8. Each figure shows successive frames 101-105, uplink (UL) 111 and downlink (DL) 112 transmissions for each frame.

As described above, we set

H-ARQ ACK Delay=1, and

H-FDD Group Switching Delay=2.

The MS receives a group switch request 121 during frame n. A group switching ACK is requested in the DL of frame n+1.

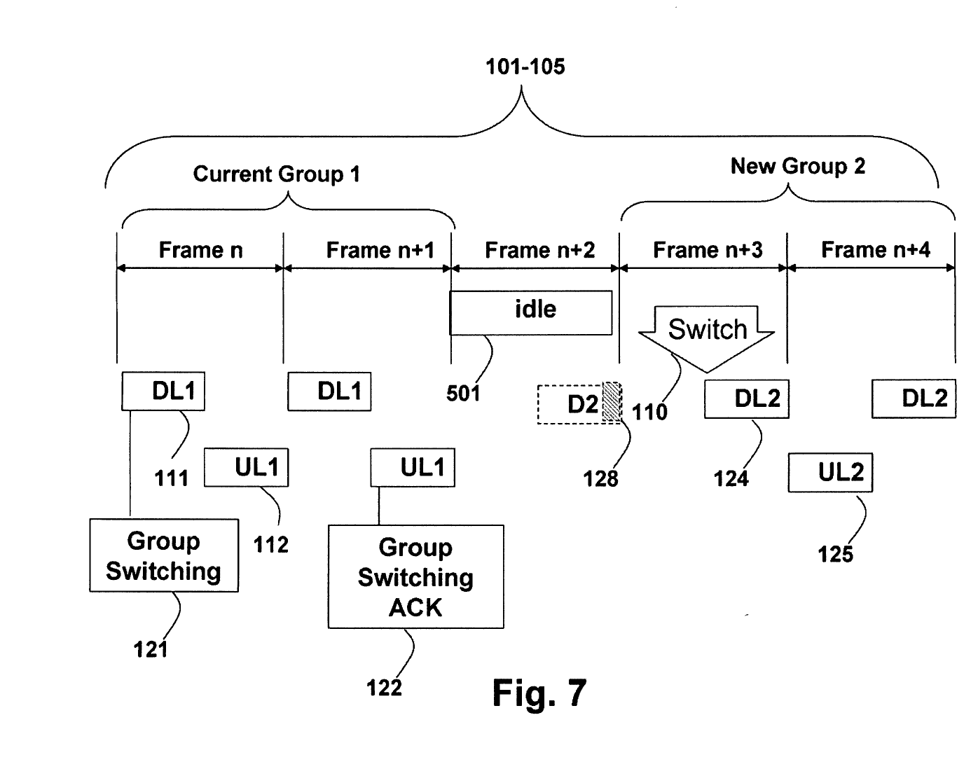

Then, if the MS is requested to switch from group 1 to group 2, as shown in FIGS. 6-7, the MS receives downlink data traffic in DLL The MS transmits the group switching ACK 122 in the UL1 from n+1.

It should be noted that the switching from group 2 to group 1 is identical to switching from group 1 to group 2, but for a delay of one sub-frame and substituting DL2 and UL2 for DL1 and DL 2, respectively. Therefore, a description of switching group 1 to group makes the switching from group 2 to group 1 obvious.

During frame n+2, there is neither uplink nor downlink data traffic because the MS might not know the size of DL2. Therefore, the MS scans for the beginning of the DL2 sub-frame.

Alternatively, the structural information of the MS in transition can be transmitted at a dedicated location 128 in the DL2 sub-frame. For example, the MAP information can be located at the end of the DL2 sub-frame, see FIG. 7. Then, the MS decodes the MAP, and obtains information regarding the structure for subsequent frames.

During frame n+3 after the switch 110, the MS receives its first DL2 data traffic 124 in the new group. During frame n+4, the MS transmits its first UL2 data traffic 125 in the new group.

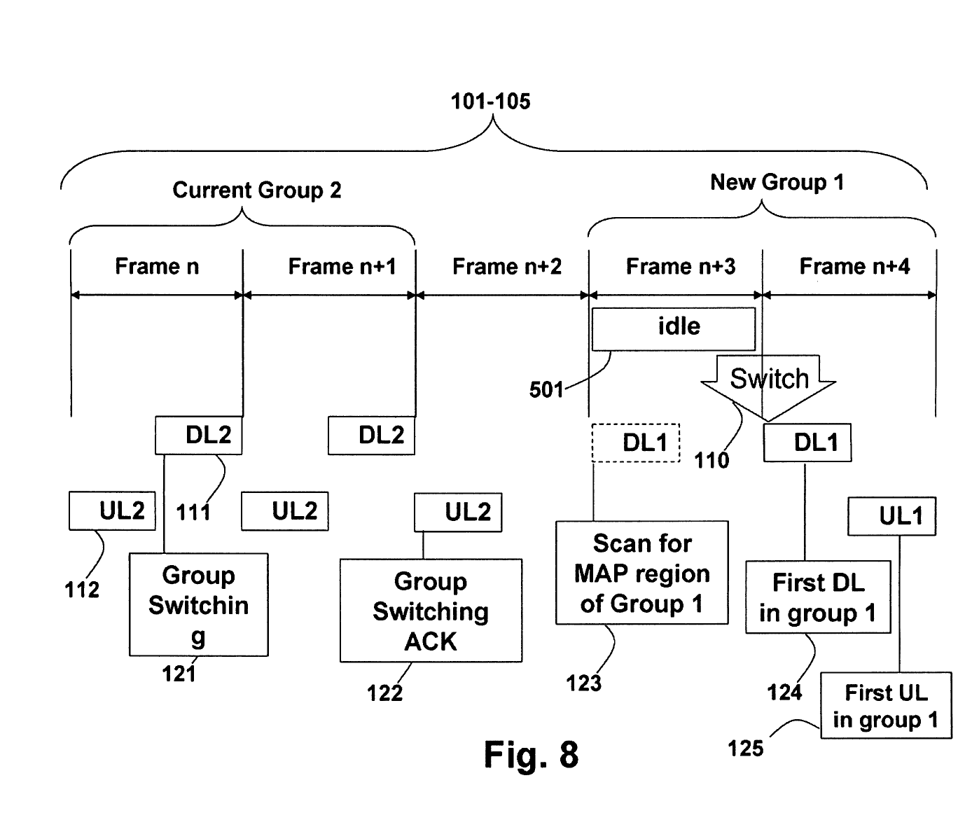

If the MS is requested to switch from group 2 to group 1, as shown in FIG. 8, the MS transmits the group switching ACK 122 in the UL2 in frame n+2. The MS does not receive any data traffic in DL2.

During the idle frame n+3 501, there is neither uplink nor downlink data traffic. The MS decodes 123 the MAP in DL1, and obtains the size of the UL1 and the region for its UL data traffic at frame n+4. During frame n+4, the MS receives 124 and transmits 125 its first DL and UL data traffic in the new group.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for switching a mobile station (MS) from a current group to a new group in a Worldwide Interoperability for Microwave Access (WiMAX) including a base station (BS), comprising:
operating the BS in full duplex mode;
operating the MS in half-duplex mode such that the WiMAX network operates in semi-duplex mode;
receiving, in the MS from the BS while the MS is in the current group, a group switching request in a downlink (DL) sub-frame;
receiving, in the MS from the BS while the MS is in the current group, structural information regarding frames of the new group in the DL sub-frame; and
switching, in the MS, from the current group to the new group after receiving the structural information.

2. The method of claim 1, further comprising:
acknowledging the group switching request from the MS to the BS in response to receiving the group switching request.

3. The method of claim 1, further comprising:
transmitting and receiving, between the MS and the BS while the MS is in the new group, data traffic after the switching.

4. The method of claim 1, further comprising:
transmitting, from the BS to the MS, one or more idle frames after transmitting the group switching request, and before the MS switches to the new group.

5. The method of claim 4, further comprising:
determining, in the MS while the BS is transmitting the one or more idle frames, the structural information.

6. The method of claim 1, in which the structural information is included with the group switching request.

7. The method of claim 1, in which the structural information for the new group includes a start of a DL MAP, a UL sub-frame size, a DL sub-frame size, a UL region for data, and a DL region for data.

8. The method of claim 1, in which structural information is determines from the one or more idle frames.

9. The method of claim 1, in which the structural information is received in a DL sub-frame of the new group while the MS is in the current group.
